(19) United States
(12) Patent Application Publication
(10) Pub. No.: US 2021/0193362 A1
(43) Pub. Date: Jun. 24, 2021

(54) MAGNETIC BASE BODY CONTAINING METAL MAGNETIC PARTICLES AND ELECTRONIC COMPONENT INCLUDING THE SAME

(71) Applicant: TAIYO YUDEN CO., LTD., Tokyo (JP)

(72) Inventor: Takumi TSUCHIYA, Tokyo (JP)

(21) Appl. No.: 17/129,375

(22) Filed: Dec. 21, 2020

(30) Foreign Application Priority Data
Dec. 20, 2019 (JP) 2019-230336

(51) Int. Cl. H01F 27/255; H01F 27/28; H01F 41/02

(52) U.S. Cl. CPC H01F 27/255; H01F 41/0246; H01F 27/28

(57) ABSTRACT

A magnetic base body according to one embodiment of the invention includes a plurality of first metal magnetic particles made of a first magnetic material and having a first average particle size, a coating film that is made of an insulating coating material having a magnetic permeability lower than the first magnetic material and covers each of the plurality of first metal magnetic particles, a plurality of second metal magnetic particles having a second average particle size smaller than the first average particle size, and a binder that is made of a resin material having a magnetic permeability lower than the first magnetic material and binds the plurality of first metal magnetic particles and the plurality of second metal magnetic particles. Each of the plurality of second metal magnetic particles directly contacts with the binder on its outer surface.

### TECHNICAL FIELD

This application is based on and claims the benefit of priority from Japanese Patent Application Serial No. 2019-230336 (filed on Dec. 20, 2019), the contents of which are hereby incorporated by reference in its entirety.

The present invention relates to a magnetic base body containing metal magnetic particles and an electronic component including the magnetic base body.

### BACKGROUND

A metal composite type magnetic base body is known as a magnetic substrate for electronic components such as inductors. In the metal composite type magnetic base body, a large number of metal magnetic particles are bonded to each other by a binder made of a resin material. The metal composite magnetic base body is produced by, for example, making a slurry by mixing and kneading magnetic particles and a resin material, pouring the slurry into a mold, and applying pressure to the slurry in the mold.

Magnetic base bodies for electronic components are required to have a high magnetic permeability. Efforts have been made to improve the magnetic permeability of the magnetic base bodies. For example, Japanese Patent Application Publication No. 2016-208002 (“the '002 Publication”) proposes that two or more types of metal magnetic particles having different average particle sizes may be mixed together to increase the magnetic particle filling factor (filling density) in the metal composite type magnetic base body.

Japanese Patent Application Publication No. 2018-041955 (“the '955 Publication”) discloses a metal composite type magnetic base body containing metal magnetic particles whose surfaces are coated with a resin layer. The resin layer coating the metal magnetic particle is a single layer made of a macromolecular material and thus serves as an insulator, a binder and a hardener. According to the disclosure of the '002 Publication, the resin layer is in direct contact with the metal magnetic particle which allows any magnetic materials to be used to form the metal magnetic particles. The '002 Publication claims that an inductor with a high magnetic permeability can be consequently provided. The '002 Publication also describes that the metal magnetic particles may be a particle mixture obtained mixing together two or more types of metal magnetic particles having different average particle sizes.

Surface of the metallic magnetic particles described in the '002 Publication are not covered with an insulating film. Thus, if the filling factor of the metal magnetic particles in the magnetic substrate is increased, the adjacent metal magnetic particles are likely to come into contact with each other. When the adjacent metal magnetic particles come into contact with each other in the magnetic base body of an inductor. Consequently a magnetic flux concentrates at the position where the metal magnetic particles contact each other when a current flowing through the coil changes. This leads to a local magnetic saturation near the contact position, which is undesirable. Moreover, such a local magnetic saturation in the magnetic base body deteriorates a DC bias characteristic of the inductor.

By coating the surface of each metal magnetic particle with an insulating film, it is possible to prevent the adjacent metal magnetic particles from electrically contacting each other. However, as described in the '955 Publication, when all of the two or more types of the metal magnetic particles having different particle sizes coated with the insulating film, the filling factor of the metal magnetic particles in the magnetic base body is decreased by the amount of the insulating film. In other words, the insulating film that coats the metal magnetic particles hampers improvement in the filling factor of the metal magnetic particles.

### SUMMARY

One object of the present invention is to overcome at least a part of the above drawback. One specific object of the invention is to provide a magnetic base body having a high filling factor of metal magnetic particles and a uniform magnetic flux distribution. The challenges achieved by the invention disclosed herein will be apparent through the description of the entire specification. The invention disclosed herein may solve an object other than the above.

A magnetic base body according to one aspect of the invention includes a plurality of first metal magnetic particles made of a first magnetic material and having a first average particle size, a coating film that is made of an insulating material having a magnetic permeability lower than the first magnetic material and covers each of the plurality of first metal magnetic particles, a plurality of second metal magnetic particles having a second average particle size smaller than the first average particle size, and a binder that is made of a resin material having a magnetic permeability lower than the first magnetic material and binds the plurality of first metal magnetic particles and the plurality of second metal magnetic particles. Each of the plurality of second metal magnetic particles directly contacts with the binder on its outer surface.

In the magnetic base body, the plurality of second metal magnetic particles may be arranged at positions that do not overlap with a virtual center line connecting centers of two adjacent first metal magnetic particles among the plurality of first metal magnetic particles.

In the magnetic base body, at least some of the plurality of second metal magnetic particles may be in contact with the coating film.

In the magnetic base body, an aspect ratio of the second metal magnetic particle may be in a range of 1.0 to 1.4.

In the magnetic base body, the average particle size of the plurality of first metal magnetic particles may be in a range of 10 to 50 μm.

In the magnetic base body, the average particle size of the plurality of second metal magnetic particles may be in a range of 0.1 to 5 μm.

In the magnetic base body, the average particle size of the plurality of second metal magnetic particles may be 10% or less of the average particle size of the plurality of first metal magnetic particles.

In the magnetic base body, the distance between two adjacent particles among the plurality of first metal magnetic particles may be 10 times or less the average particle size of the plurality of second metal magnetic particles.

In the magnetic base body, the distance between the two adjacent particles among the plurality of first metal magnetic particles may be in a range of 10 nm to 15 μm.

In the magnetic base body, a filling factor of the plurality of first metal magnetic particles and the plurality of second metal magnetic particles together in the magnetic base body may be 85% or more.

An electronic component according to another aspect of the invention may include the above magnetic base body and a coil conductor embedded in the magnetic base body.

According to the present disclosure it is possible to provide a magnetic base body having a high filling factor of metal magnetic particles and a uniform magnetic flux distribution.

### BRIEF DESCRIPTION OF THE DRAWINGS

FIG. 1 is a perspective view of a coil component including a magnetic base body relating to an embodiment of the invention.

FIG. 2 is a view schematically showing a cross section of the coil component of FIG. 1 cut along the line I-I.

FIG. 3A is an enlarged schematic view of a region A of the magnetic base body of FIG. 2.

FIG. 3B is an enlarged schematic view of a region corresponding to the region A of the magnetic base body in another embodiment of the invention.

FIG. 4 is an enlarged sectional view of a second metal magnetic particle shown in FIG. 3.

FIG. 5 is a perspective view of a coil element according to another embodiment of the invention.

FIG. 6 is a front view of the coil component according to another embodiment of the invention.

### DESCRIPTION OF THE EMBODIMENTS

Various embodiments of the present invention will be hereinafter described with reference to the accompanying drawings. Reference characters designating corresponding components are repeated as necessary throughout the drawings for the sake of consistency and clarity. For convenience of explanation, the drawings are not necessarily drawn to scale.

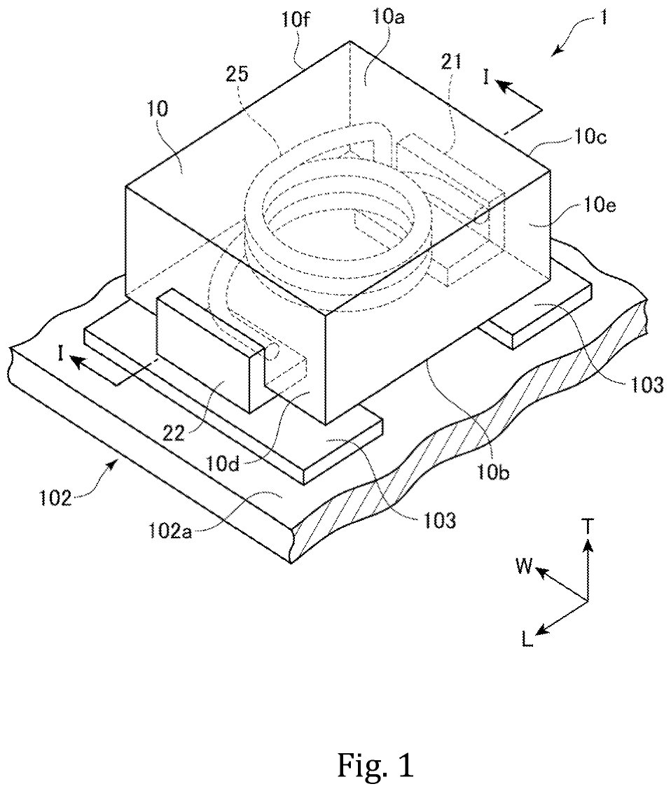

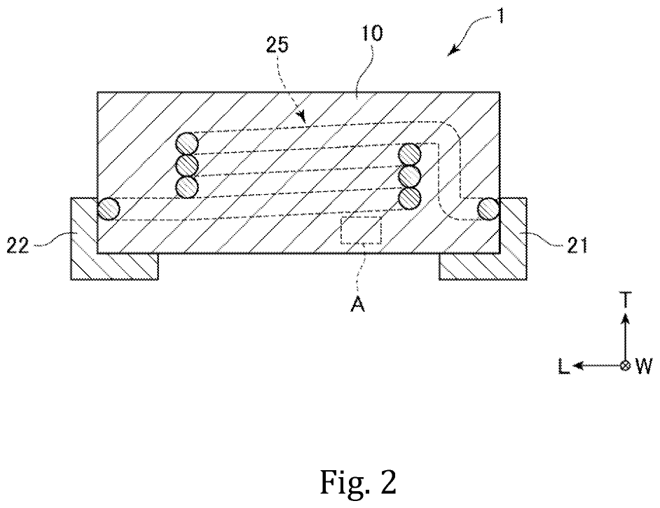

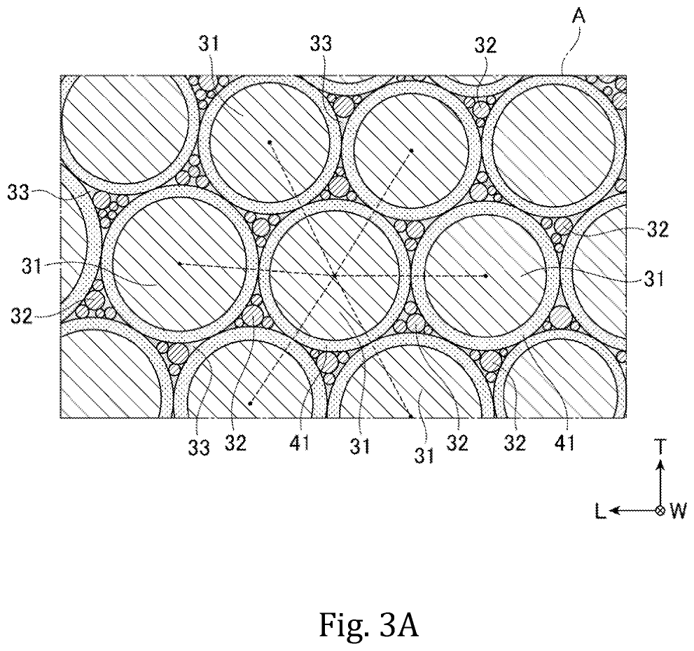

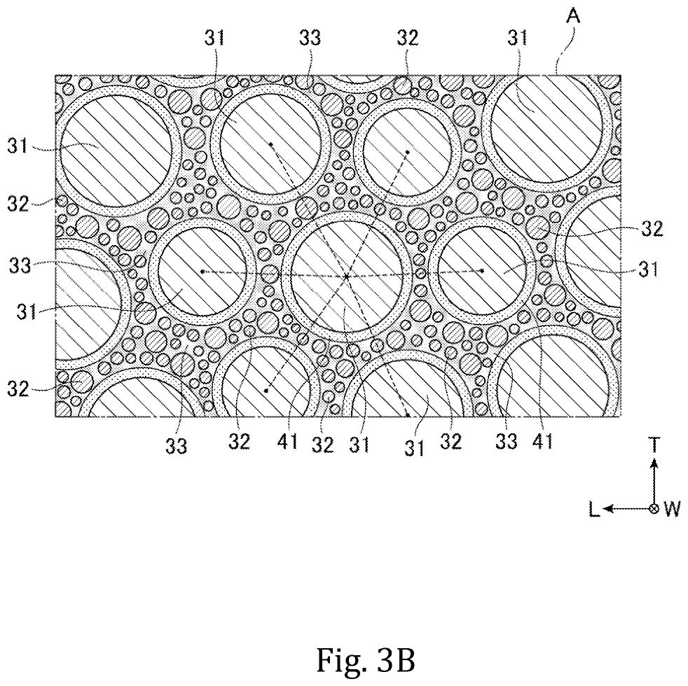

An electronic component including a magnetic base body 10 according to one embodiment of the invention will be hereinafter described with reference to FIGS. 1 to 3. These drawings show a coil component 1 as an example of the electronic component including the magnetic base body 10. FIG. 1 is a perspective view of a coil component according to one embodiment of the invention, FIG. 2 is a schematic sectional view of the coil component along the line I-I in FIG. 1, and FIG. 3 schematically illustrates a captured image of a region A of the section of FIG. 2.

In this specification, a “length” direction, a “width” direction, and a “thickness” direction of the coil component 1 correspond to the “L axis” direction, the “W axis” direction, and the “T axis” direction in FIG. 1, respectively, unless otherwise construed from the context.

The coil component 1 is, for example, an inductor. The inductor is an example of the coil component to which the invention can be applied to. The invention can also be applied to transformers, filters, reactors, and various any other coil components. Advantageous effects of the invention will be more remarkably exhibited if the invention is applied to coil components and any other electronic components to which large current is applied. An inductor used in a DC-DC converter is an example of a coil component to which large current is applied. The invention may be also applied to coupled inductors, choke coils, and any other magnetically coupled coil components, in addition to the inductors used in DC-DC converters. Applications of the coil component 1 are not limited to those explicitly described herein.

As illustrated in the accompanying drawings, the coil component 1 includes a metal composite type magnetic base body 10, a coil conductor 25 embedded in the magnetic base body, an external electrode 21 electrically connected to one end of the coil conductor 25, and an external electrode 22 electrically connected to the other end of the coil conductor 25.

The illustrated coil component 1 is mounted on a mounting substrate 102a. The mounting substrate 102a may have land portions 103 provided thereon. In the case where the coil component 1 includes two external electrodes 21 and 22, the mounting substrate 102a is provided with two landing portions 103 correspondingly. The coil component 1 may be mounted on the mounting substrate 102a by joining the external electrodes 21, 22 to the corresponding land portions 103 of the mounting substrate 102a. A circuit board 102 according to one embodiment includes the mounting substrate 102a and the coil component 1 mounted on the mounting substrate 102a. The circuit board 102 can be installed in various electronic devices. Electronic devices in which the circuit board 102 may be installed include smartphones, tablets, game consoles, electrical components of automobiles, and various other electronic devices. The coil component 1 may be embedded in the mounting substrate 102a.

The magnetic base body 10 has a substantially rectangular parallelepiped shape. In one embodiment of the invention, the magnetic base body 10 has a length (the dimension in the direction L) of 1.0 to 2.6 mm, a width (the dimension in the direction W) of 0.5 to 2.1 mm, and a thickness (the dimension in the direction T) of 0.5 to 1.0 mm. The length of the magnetic base body may be 0.3 to 1.6 mm, the width may be 0.1 to 0.8 mm, and the the thickness may be 0.1 to 0.8 mm. The top surface and the bottom surface of the magnetic base body 10 may be covered with a cover layer.

The magnetic base body 10 has a first principal surface 10a, a second principal surface 10b, a first end surface 10c, a second end surface 10d, a first side surface 10e, and a second side surface 10f. The outer surface of the magnetic base body 10 may be defined by these six surfaces. The first principal surface 10a and the second principal surface 10b are opposed to each other, the first end surface 10c and the second end surface 10d are opposed to each other, and the first side surface 10e and the second side surface 10f are opposed to each other. As shown in FIG. 1, the first principal surface 10a lies on the top side in the magnetic base body 10, and therefore, the first principal surface 10a may be herein referred to as “the top surface.” Similarly, the second principal surface 10b may be referred to as “the bottom surface.” The coil component 1 is disposed such that the second principal surface 10b faces a circuit board 102, and therefore, the second principal surface 10b may be herein referred to as a “mounting surface.” The top-bottom direction of the coil component 1 refers to the top-bottom direction (the direction along the axis T) in FIG. 1.

The external electrode 21 is provided on the first end surface 10c of the magnetic base body 10. The external electrode 22 is provided on the second end surface 10d of the magnetic base body 10. As shown, these external electrodes may extend to the bottom surface of the magnetic base body 10. The shapes and positions of the external electrodes are not limited to the illustrated example. For example, both of the external electrodes 21, 22 may be provided on the bottom surface 10b of the magnetic base body 10. The external electrodes 21 and 22 are separated from each other in the length direction.

The magnetic base body 10 will be further described in detail with reference to FIG. 3A. The schematic cross section of the magnetic base body 10 is shown in FIG. 3A. FIG. 3A schematically shows a scanning electron microscope (SEM) image of the region A of the cross section of the magnetic base body 10 taken by SEM with a magnification ratio of 2000. As the scanning electron microscope, S-4300 available from Hitachi High Technologies Corporation can be used. The region A may be an arbitrary region in the magnetic base body 10. The distributions of a plurality of first metal magnetic particles 31 and a plurality of second metal magnetic particles 32 on the cross section of the magnetic base body 10 are examined with a scanning electron microscope suitably with a magnification ratio of 1000 to 3000, for example. When the cross section of the magnetic base body 10 is observed, the magnification ratio of the scanning electron microscope can be adjusted between 1000 to 3000 as appropriate.

As shown in the drawing, the magnetic base body 10 includes the plurality of the first metal magnetic particles 31, the plurality of second metal magnetic particles 32, and a binder 33. Each of the first metal magnetic particles 31 is covered with a coating film 41. The binder 33 binds together the plurality of first metal magnetic particles 31 and the plurality of second metal magnetic particles 32. In other words, the magnetic base body 10 includes the binder 33 and the plurality of first metal magnetic particles 31 and the plurality of second metal magnetic particles 32 bound to each other by the binder 33.

In one embodiment, the first metal magnetic particles 31 and the second metal magnetic particles 32 are fine particles made of soft magnetic materials. The first metal magnetic particles 31 are made of a first magnetic material, and the second metal magnetic particles 32 are made of a second magnetic material. The first and second magnetic materials may be a crystalline or amorphous metal or alloy containing at least one element selected from the group consisting of iron (Fe), nickel (Ni) and cobalt (Co). The first and second metal magnetic materials may further contain at least one element selected from the group consisting of silicon (Si), chromium (Cr) and aluminum (Al). The first and second metal magnetic particles 31 and 32 may be pure iron particles containing Fe and unavoidable impurities, or particles of an Fe-based amorphous alloy containing iron (Fe). The Fe-based amorphous alloy includes, for example, Fe—Si alloy, Fe—Si—Al alloy, Fe—Si—Cr—B alloy, Fe—Si—B—C alloy, and Fe—Si—P—B—C alloy. The first magnetic material and the second magnetic material may be the same magnetic material or different magnetic materials from each other. The second magnetic material may be a magnetic material having a magnetic permeability smaller than that of the first magnetic material. When the first magnetic material and the second magnetic material are the same magnetic material, the average particle size of the second metal magnetic particles 32 is smaller than the average particle size of the first metal magnetic particles 31, as will be described later. Thus the magnetic permeability of the second metal magnetic particles measured in a single particle is smaller than the magnetic permeability of the first metal magnetic particles 31 measured in a single particle. The Fe content ratio in the second magnetic material may be higher than the Fe content ratio in the first magnetic material.

The average particle size of the plurality of first metal magnetic particles 31 is hereinafter referred to as a first average particle size and the average particle size of the plurality of second metal magnetic particles 32 is hereinafter referred to as a second average particle size. The average particle size of the first metal magnetic particles 31 here referrers to the average particle size of the first metal magnetic particles 31 that do not have the coating film 41 thereon. The second average particle size of the second metal magnetic particles 32 is smaller than the first average particle size of the first metal magnetic particles 31. The average particle size of the metal magnetic particles (for example, the first metal magnetic particles 31 and the second metal magnetic particles 32) included in the magnetic base body 10 is determined in the following manner. The magnetic base body is cut along the thickness direction (the T direction) to expose the cross section. The cross section is photographed using a scanning electron microscope (SEM) with a magnification ratio of 1000 to 3000, and the photograph is used to obtain a particle size distribution. The particle size distribution is used to determine the average particle size. For example, the 50th percentile of the particle size distribution obtained based on the SEM image can be used as the average particle size of the metal magnetic particles. The first metal magnetic particles 31 in the magnetic base body 10 may have the average particle size of 10 to 50 μm, and the second metal magnetic particles 32 may have the average particle size of 1 to 5 μm. The average particle size of the second metal magnetic particles 32 may be 10% or less of the average particle size of the first metal magnetic particles 31. The particle size distribution of the second metal magnetic particles 32 obtained based on the SEM image may exhibit two or more peaks. In other words, the second metal magnetic particles 32 may be a particle mixture obtained mixing together two types of metal magnetic particles having different average particle sizes.

The binder 33 is, for example, a thermosetting resin having a high insulating property. A resin material used as the material of the binder 33 has a smaller magnetic permeability than the first magnetic material. Examples of the resin material of the binder 33 include an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, or a polybenzoxazole (PB 0) resin.

As mentioned above, each of the first metal magnetic particles 31 is covered with the coating film 41. The coating film 41 is formed of an insulating material having an excellent insulating property. The insulating material for the coating film 41 may be an organic material or an inorganic material. The material of the coating film 41 has a smaller magnetic permeability than the first magnetic material. As the organic material for the coating film 41, the second insulating layer 42, and the third insulating layer 43, epoxy, phenol, silicone, polyimide, or any other thermosetting resin can be used. When silicone is used as the organic material for the coating film 41, the first metal magnetic particles 31 are immersed in a silicone resin solution in which a silicone resin is dissolved in a petroleum-based organic solvent such as xylene, and then the organic solvent is evaporated from the resin solution to form the coating film 41 on the surfaces of the first metal magnetic particles 31. In order to improve the uniformity of the film thickness, the silicone resin solution may be stirred, if necessary. As the inorganic material for the coating film 41, phosphate, borate, chromate, glass (for example, SiO₂), and metal oxide (for example, Fe₂O₃ or Al₂O₃) can be used. The coating film 41 may be formed by a powder mixing method, an immersion method, a sol-gel method, a CVD method, a PVD method, or various other known methods. The coating film 41 may be an oxide film formed by oxidizing metal or alloy contained in the first metal magnetic particles 31. This oxide film is formed by performing heat treatment at 400 to 800° C. for about 20 minutes to 3 hours in a low oxygen concentration atmosphere having an oxygen concentration of about 500 to 1000 ppm.

It is preferable that the coating film 41 be formed to cover the entire surface of the first metal magnetic particle 31 so that the first metal magnetic particles 31 do not directly contact with other metal magnetic particles, which prevents the particles from being shorted out. Note that the coating film 41 may sometime cover only a part of the surface of the first metal magnetic particle 31, not the entire surface. In the manufacturing process of the magnetic base body 10, a part of the coating film 41 may incidentally come off from the first metal magnetic particle 31. In such a case, the coating film 41 will cover only a part of the surface of the first metal magnetic particle, not the entire surface.

A thickness of the coating film 41 may be 5 nm to 1 nm. The material for the coating film 41 may include two or more layers made of different materials. The coating film 41 can be distinguished from the first metal magnetic particles 31 and the binder 33 based on the difference in brightness in the SEM image. The coating film 41 can also be distinguished from the binder 33 by SEM-EDS mapping.

As shown in FIG. 3A, the plurality of second metal magnetic particles 32 are not coated with a film such as a coating film 41. Therefore, each of the plurality of second metal magnetic particles directly contacts with the binder 33 on its outer surface. As described above, the first metal magnetic particles 31 are in contact with the binder 33 via the coating film 41, while the second metal magnetic particles 32 are in direct contact with the binder 33.

In the embodiment shown in FIG. 3A, the second metal magnetic particles 32 are arranged at positions that do not overlap with a virtual center line connecting the centers of two adjacent first metal magnetic particles 31. In this case, most of the second metal magnetic particles 32 are arranged in regions called a triple point surrounded by three or more first metal magnetic particles 31. The centers of the first metal magnetic particle 31 may refer to the geometric centers of gravity of the first metal magnetic particles 31. FIG. 3A uses broken lines to identify the imaginary lines connecting the center of gravity of the first metal magnetic particle 31 that is arranged at approximately the center of the field of view and the centers of gravity of six first metal magnetic particles 31 adjacent to the first metal magnetic particle 31 at the center of the field of view. The second metal magnetic particles 32 do not overlap with any of the six virtual lines. One or more of the plurality of second metal magnetic particles 32 may be in contact with the coating films 41 covering the first metal magnetic particles 31.

FIG. 3B shows a cross section of the region A of the magnetic base body 10 according to another embodiment of the invention. In this embodiment, the second metal magnetic particles 32 are arranged at positions that overlap with the virtual center line connecting the centers of the adjacent first metal magnetic particles 31 as shown in FIG. 3B, Thus, even if the distance between the adjacent first metal magnetic particles 31 becomes large, a region between the adjacent first metal magnetic particles 31 is filled with the second metal magnetic particles 32, which prevents decrease in the filling factor.

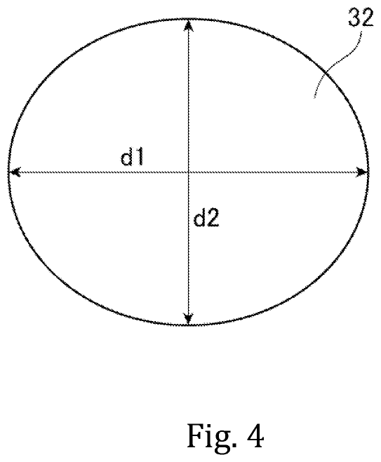

As shown in FIG. 4, the second metal magnetic particles 32 may have a flattened circular shape. For example, the aspect ratio of each of the second metal magnetic particles 32 may be in the range of 1.0 to 1.4. When the size of the second metal magnetic particle is less than 1 nm, the aspect ratio of the second metal magnetic particle may be in the range of 1.0 to 1.1. The aspect ratio of the second metal magnetic particle 32 is represented by a ratio of a shortest axis d2 of the second metal magnetic particle 32 to a longest axis d1 (in other words, d1/d2). The aspect ratio of the first metal magnetic particle 31 may be smaller than the aspect ratio of the second metal magnetic particle. By setting the aspect ratios of the first metal magnetic particle 31 and the second metal magnetic particle 32 to the above range, for example, distortion inside each metal magnetic particle generated through the manufacturing process of the magnetic base body 10 can be reduced. Consequently it is possible to prevent deterioration of the relative magnetic permeability.

In one embodiment, the plurality of first metal magnetic particles 31 may be arranged such that the distance between adjacent first metal magnetic particles 31 is 10 times or less the average particle size of the second metal magnetic particles 32. Alternatively, in one embodiment, the distance between the adjacent first metal magnetic particles 31 is 5 times or less the average particle size of the second metal magnetic particles 32. Alternatively, in one embodiment, the distance between the adjacent first metal magnetic particles 31 is 3 times or less the average particle size of the second metal magnetic particles 32. For example, the distance between adjacent first metal magnetic particles 31 may be in the range of 10 nm to 15 μm. The distances between one first metal magnetic particle 31 and adjacent first metal magnetic particles 31 may be measured for each of the first metal magnetic particles 31 in the field of view in the SEM image of the cross section of the magnetic base body 10, and the average of the measured distances can be herein defined as the distance between the adjacent first metal magnetic particles 31. The distance between the two adjacent first metal magnetic particles 31 referrers to the closest distance between the two adjacent first metal magnetic particles. In most cases, the closest distance between the two adjacent first metal magnetic particles 31 is a distance between the two adjacent first metal magnetic particles along the virtual center line connecting the centers of the two adjacent first metal magnetic particles 31. When the second metal magnetic particles 32 are arranged on the virtual center line connecting the centers of the adjacent first metal magnetic particles 31, the distance between the adjacent first metal magnetic particles 31 may exceed three times the average particle size of the plurality of second metal magnetic particles 32 depending on the particle size of the second metal magnetic particles 32. According to one embodiment of the invention, the second metal magnetic particles 32 are arranged at positions that do not overlap with the virtual center line connecting the centers of the adjacent first metal magnetic particles 31, so that the plurality of first metal magnetic particles 31 can make the distance between the adjacent first metal magnetic particles 31 three times or less the average particle size of the second metal magnetic particles 32.

In one embodiment, the filling factor of the first metal magnetic particles 31 and the second metal magnetic particles 32 together in the magnetic base body 10 is 85 vol % or more. The filling factor of the first metal magnetic particles 31 and the second metal magnetic particles 32 together in the magnetic base body 10 may be defined as a ratio of the area occupied by the metal magnetic particles (that is, a sum of the total area occupied by the plurality of first metal magnetic particles 31 and the total area of the plurality of second metal magnetic particles 32) to the whole area of the field of view in the SEM image of the cross section of the magnetic base body 10. In conventional magnetic base body, the upper limit of the filling factor was about 80 vol %. Whereas in the magnetic base body 10 of the present application, the second metal magnetic particles 32 are not coated with the coating film, and the second metal magnetic particles 32 are not situated on the virtual center line connecting the centers of the adjacent first metal magnetic particles 31. Thus the filling factor of the first metal magnetic particles 31 and the second metal magnetic particles 32 in the magnetic base body 10 can be increased, more specifically, a filling factor of 85 vol % or more can be realized.

An example of manufacturing method of the coil component 1 according to one embodiment of the invention will now be described. The following describes a method of manufacturing the coil component 1 using a compression molding process. The first metal magnetic particles 31 and the second metal magnetic particles 32 are first prepared. The coating film 41 is then formed on the surfaces of the first metal magnetic particles 31. The coating film 41 is formed on the surface of each of the plurality of first metal magnetic particles 31 by, for example, a sol-gel method. Subsequently, the first metal magnetic particles 31 coated with the coating film 41 and the second metal magnetic particles 32 are mixed to obtain a mixture of particles (mixed powder). The mixture of particles can be obtained, for example, by mixing 75 wt % of the first metal magnetic particles 31 and 25 wt % of the second metal magnetic particles 32. The mixing ratio of the first metal magnetic particles 31 and the second metal magnetic particles 32 in the mixed particles can be adequately changed. For example, the mixture of particles may be a mixture of 90 wt % of the first metal magnetic particles 31 and 10 wt % of the second metal magnetic particles 32. As another example, the mixture of particles may be a mixture of 60 wt % of the first metal magnetic particles 31 and 40 wt % of the second metal magnetic particles 32. The first metal magnetic particles 31 in the mixture of particles may be in the range of 60 to 90 wt %, and the second metal magnetic particles 31 in the mixture may be in the range of 10 to 40 wt %.

Next, the above mixture of particles, a resin material that serves as the binder 33 after curing, and a diluting solvent are mixed and kneaded to prepare a slurry. The first metal magnetic particles 31 coated with the coating film 41 and the second metal magnetic particles 32 are dispersed in the slurry. Tarpineol (TPO) can be used as the diluting solvent. The slurry is then applied on a substrate such as a PET film in the form of a sheet, and the applied slurry is dried to volatilize the diluting solvent. Through the above process, a magnetic sheet in which the first metal magnetic particles 31 coated with the coating film 41 and the second metal magnetic particles 32 are dispersed in the resin can be obtained.

Subsequently, the coil conductor 25 prepared in advance is placed in a molding die, the above magnetic sheet is then placed in the molding die, and a molding pressure is applied thereto at a temperature of, for example, 50 to 150° C., and then further heated from 150 to 400° C. for curing. In this way, the magnetic base body 10 including the coil conductor 25 thereinside can be obtained. The heat treatment for obtaining the magnetic base body 10 may be performed in two steps as described above or in one step. When the heat treatment is performed in one step, molding and curing are performed during the heat treatment. In the magnetic base body 10, the resin contained in the slurry is cured and serves as the binder 33. The magnetic base body 10 may be warm molded at a temperature of, for example, around 80° C. The molding pressure for molding is, for example, 50 to 200 MPa. The molding pressure can be appropriately adjusted to obtain a desired filling factor. The molding pressure is, for example, 100 MPa.

Next, a conductor paste is applied to a surface of the magnetic base body 10, which is produced in the above-described manner, to form the external electrodes 21 and 22. The external electrode 21 is electrically connected to one end of the coil conductor 25 inside the magnetic base body 10, and the external electrode 22 is electrically connected to the other end of the coil conductor 25 inside the magnetic base body 10. The coil component 1 is obtained, as described above.

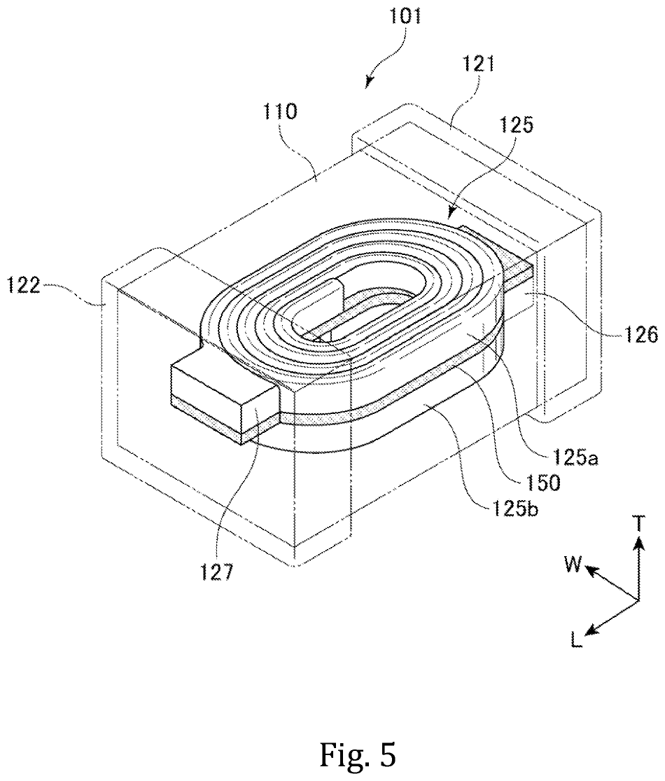

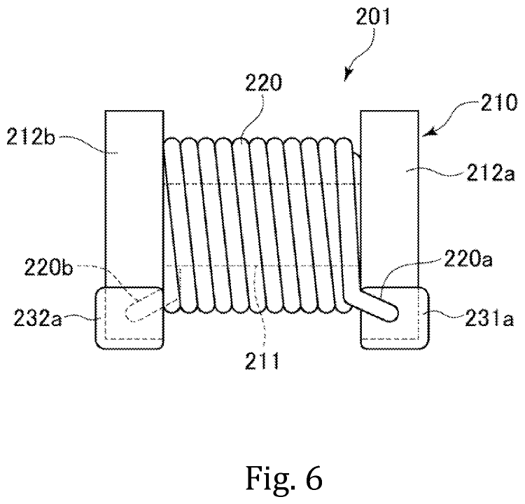

The following describes a coil component 101 according to another embodiment of the invention with reference to FIG. 5. The coil component 101 is a planar coil. As shown in FIG. 6, the coil component 101 according to the embodiment includes a magnetic base body 110, an insulating plate 150 provided in the magnetic base body 110, a coil conductor 125 provided on upper and lower surfaces of the insulating plate 150 in the magnetic base 110, an external electrode 121 provided on the magnetic base body 110, and an external electrode 122 provided on the magnetic base body 110 at a position apart from the external electrode 121.

In the embodiment, similarly to the above-described magnetic base body 10, the magnetic base body 110 includes the plurality of first metal magnetic particles 31, the plurality of second metal magnetic particles 32, and the binder 33. The insulating plate 150 is made of an insulating material and has a plate-like shape. The insulating material used for the insulating plate 150 may be magnetic. The magnetic material used for the insulating plate 150 is, for example, a composite magnetic material containing a binder and metal magnetic particles.

In the embodiment shown, the coil conductor 125 includes a coil conductor 125a formed on the upper surface of the insulating plate 150 and the coil conductor 125b formed on the lower surface of the insulating plate 150. The coil conductor 125a and the coil conductor 125b are connected by a via (not shown). The coil conductor 125a is formed in a predetermined pattern on the upper surface of the insulating plate 150, and the coil conductor 125b is formed in a predetermined pattern on the lower surface of the insulating plate 150. An insulating film may be provided on surfaces of the coil conductors 225a and 225b. The coil conductor 125 can be provided in various shapes. When seen from above, the coil conductor 125 has, for example, a spiral shape, a meander shape, a linear shape or a combined shape of these.

In one embodiment of the invention, the insulating plate 150 has a larger resistance than the magnetic base body 110. Thus, even when the insulating plate 150 has a small thickness, electric insulation between the coil conductor 125a and the coil conductor 125b can be ensured.

A lead-out conductor 127 is provided on one end of the coil conductor 125a, and a lead-out conductor 126 is provided on one end of the coil conductor 125b. In this manner, the coil conductor 125 is electrically coupled to the external electrode 121 via the lead conductor 126 and is electrically coupled to the external electrode 122 via the lead conductor 127.

Next, a description is given of an example of a manufacturing method of the coil component 101. To start with, an insulating plate made of a magnetic material and shaped like a plate is prepared. Next, a photoresist is applied to the top surface and the bottom surface of the insulating plate, and then conductor patterns are transferred onto the top surface and the bottom surface of the insulating plate by exposure, and development is performed. As a result, a resist having an opening pattern for forming a coil conductor is formed on each of the top surface and the bottom surface of the insulating plate. For example, the conductor pattern formed on the top surface of the insulating plate corresponds to the coil conductor 125a described above, and the conductor pattern formed on the bottom surface of the insulating plate corresponds to the coil conductor 125b described above. A through-hole for the via is formed in the insulating plate.

Subsequently, plating is performed to fill each of the opening patterns with a conductive metal. Next, etching is performed to remove the resists from the insulating plate, so that the coil conductors are formed on the top surface and the bottom surface of the insulating plate. Further, the through-hole in the insulating plate is filled with a conductive metal to form the via that connects the coil conductor 125a and the coil conductor 125b.

A magnetic base body is subsequently formed on both surfaces of the insulating plate where the coil conductors have formed thereon. This magnetic base body corresponds to the magnetic base body 110 described above. To form the magnetic base body 110, magnetic sheets are first fabricated. The magnetic sheet can be produced in the same manner as the magnetic sheet used in the manufacturing process of the coil component 1. Two magnetic sheets are prepared, and the above-described coil conductor is placed between the two magnetic sheets and pressure is applied to them while they are heated. In this way, a laminated body is fabricated. The method for producing the laminated body is not limited to the above. In another method of producing the laminated body, an insulating plate on which a coil conductor has been fabricated is first placed in the molding die. Subsequently the mixture of particles in which the plurality of first metal magnetic particles 31 coated with the coating film 41 and the plurality of second metal magnetic particles 32 are mixed, and the resin material serving as the binder 33 are placed in the molding die and then they are pressurized while being heated to obtain the laminated body. The laminated body may be warm molded at a temperature of 50 to 150° C., for example, around 80° C. The molding pressure for molding is, for example, 50 to 200 MPa. The molding pressure can be appropriately adjusted to obtain a desired filling factor. The molding pressure is, for example, 100 MPa. Next, the laminated body is subjected to heat treatment at a curing temperature (for example, 150 to 400° C.) of the resin. In this way, the magnetic base body 110 containing the coil conductor 125 can be obtained. External electrodes 121, 122 are provided on the external surface of the magnetic base body at predetermined positions. In this manner, the coil component 101 is fabricated.

The following describes a coil component 201 according to another embodiment of the invention with reference to FIG. 6. The coil component 201 relating to one embodiment of the present invention is a winding inductor. As shown, the coil component 201 includes a drum core 210, a winding wire 220, a first external electrode 231a, and a second external electrode 232a. The drum core 210 includes a winding core 211, a flange 212a having a rectangular parallelepiped shape and provided on one end of the winding core 211, and a flange 212b having a rectangular parallelepiped shape and provided on the other end of the winding core 211. The winding wire 220 is wound on the winding core 211. The winding 220 is a conductor wire made of a metal material having excellent electrical conductivity covered with an insulation coating therearound. The first external electrode 231a extends along the bottom surface of the flange 212a, and the second external electrode 232a extends along the bottom surface of the flange 212b.

Similarly to the magnetic base body 10, the drum core 210 includes the plurality of first metal magnetic particles 31, the plurality of second metal magnetic particles 32, and the binder 33. For example, the mixture of particles obtained by mixing the plurality of first metal magnetic particles 31 coated with the coating film 41 and the plurality of second metal magnetic particles 32, and a resin material serving as the binder 33 are mixed, then the mixed material is molded and cured to produce the drum core 210. The drum core 210 may be warm molded at a temperature of 50 to 150° C., for example, around 80° C. The molding pressure for molding is, for example, 50 to 200 MPa. The molding pressure can be appropriately adjusted to obtain a desired filling factor. The molding pressure is, for example, 100 MPa. The curing temperature may be, for example, 150 to 400° C. The coil component 201 is produced by winding the winding wire 220 around the drum core 210, connecting one end of the winding wire 220 to the first external electrode 231a, and connecting the other end to the second external electrode 232a.

Advantageous effects of the above embodiments will be now described. In the magnetic base body 10 according to the above embodiment, the first metal magnetic particles 31 are covered with the coating film 41 that has a low magnetic permeability, so that magnetic contact between the adjacent first metal magnetic particles 31 is prevented. In this way, it is possible to prevent the magnetic flux from concentrating at the contact points between the the first metal magnetic particles 31 due to the magnetic connection therebetween. Further, the coating film 41 may be made of an insulating material having an excellent insulating property. In this case, electrical connection between the adjacent first metal magnetic particles 31 is also prevented, which prevents increase in the eddy current.

In the above embodiment, the second metal magnetic particles 32 are provided such that the outer surfaces thereof are in contact with the binder 33. That is, unlike the first metal magnetic particles 31, the second metal magnetic particles 32 are not covered with the coating film 41 or any other insulating film. In this way, the filling factor of the metal magnetic particles (sum of the first metal magnetic particles 31 and the second metal magnetic particles 32) in the magnetic base body 10 can be increased as compared with conventional coil components in which the insulating film is provided on the surfaces of the second metal magnetic particles 32.

In the above embodiment, the second average particle size, which is the average particle size of the second metal magnetic particles 32, is smaller than the first average particle size, which is the average particle size of the first metal magnetic particles 31. Thus a magnetic flux generated by change in the current flowing through the coil conductor 25 is more likely to pass through the first metal magnetic particles 31 than the second metal magnetic particles 32. Consequently, even if the second metal magnetic particles 32 are magnetically connected to each other, the degree of concentration of the magnetic flux at the contact points therebetween is less than the degree of concentration of the magnetic flux caused by the magnetic connection between the first metal magnetic particles. Therefore, even though the second metal magnetic particles 32 are not provided with an insulating coating film, the uniformity of the magnetic flux is less affected. In one embodiment, by arranging the second metal magnetic particles between the first metal magnetic particles, it is possible to more reliably prevent the first metal magnetic particles from being magnetically connected to each other. Further, by setting the distance between the two adjacent first metal magnetic particles to 10 times or less the average particle size of the plurality of second metal magnetic particles, it is possible to prevent magnetic connection between the first metal magnetic particles without decreasing the filling factor.

In the above embodiment, when the second metal magnetic particles 32 are situated on the virtual center line connecting the centers of the adjacent first metal magnetic particles 31, the distance between the adjacent first metal magnetic particles 31 is increased by the size of the second metal magnetic particles 32. The distance (shortest distance or shortest interval) between two adjacent first metal magnetic particles 31 referrers to the distance or interval between the two adjacent first metal magnetic particles 31 along the virtual center line connecting the centers of the two adjacent first metal magnetic particles 31. Therefore, as shown in FIG. 3A, by disposing each of the second metal magnetic particles 32 at positions not overlapping with the virtual center line connecting the centers of the two adjacent first metal magnetic particles 31, it is possible to reduce the distance between the adjacent first metal magnetic particles 32. Accordingly, by providing each of the second metal magnetic particles 32 at a position that does not overlap with the virtual center lines, the filling factor of the metal magnetic particles in the magnetic base body 10 can be increased. Since a large number of the second metal magnetic particles 32 is provided, some of them may be situated between the adjacent first metal magnetic particles 31. However, as long as the proportion of the second metal magnetic particles 32 arranged on the virtual center line connecting the centers of the first metal magnetic particles 31 is low, their effect on the filling factor of the metal magnetic particles in the magnetic base body 10 can be ignored. In one embodiment of the invention, a sectional SEM image of a region of the magnetic base body 10 that includes five or more first metal magnetic particles 31 is acquired. It can be determined that the second metal magnetic particles 32 are arranged at positions that do not overlap with the virtual center lines connecting the centers of the adjacent first metal magnetic particles 31 when it is found for each of all the first metal magnetic particles 31 in the SEM image that the second metal magnetic particles 32 do not exist on the virtual center lines connecting the center of the first metal magnetic particle 31 and the centers of the adjacent first metal magnetic particles 31.

In conventional magnetic base bodies, metal magnetic particles having a relatively small particle size are also coated with an insulating film, and a resin film is often used as the insulating film. In this case, the insulating films that cover small-diameter metal magnetic particles (which correspond to the “second metal magnetic particle 32” in the present application) serve as a primer, which makes the small-diameter metal magnetic particles be more easily bonded to large-diameter metal magnetic particles (which correspond to the “first magnetic metal magnetism 31” in the present application). As a result, the small-diameter metal magnetic particles are likely to situate between the large-diameter metal magnetic particles, and the distance between the large-diameter metal magnetic particles is increased. Whereas in the above embodiment, the second metal magnetic particles 32 are in direct contact with the binder 33 without being covered with the insulating film so that the second metal magnetic particles 32 more easily move inside the binder 33 before curing at the time of molding and tend to be pushed out to regions where do not overlap with the virtual center lines (for example, the region at the triple point of the first metal magnetic particles 31) during pressure molding. In this way, when the second metal magnetic particles 32 are not coated with an insulating material, each of the second metal magnetic particles 32 can be easily placed at a position that does not overlap with the virtual center lines connecting the centers of the adjacent first metal magnetic particles 31.

In a magnetic base body that contains two or more types of metal magnetic particles having different average particle sizes from each other, metal magnetic particles having a larger average particle size have a higher magnetic permeability than metal particles having a smaller average particle size. Therefore, magnetic flux tends to pass through a path with a high proportion of metal magnetic particles having a larger average particle size. According to the above embodiment, the first metal magnetic particles 31 having a relatively large average particle size are coated with the coating film 41 made of a material with a low magnetic permeability, while the second metal magnetic particles having a relatively small average particle size are not provided with such a coating film. Therefore, as compared with the case where the coating film is provided on the second metal magnetic particles 32, the magnetic flux generated when a current flows through the coil is more likely to pass through the path where the second metal magnetic particles 32 exist. In this way, it is possible to make the magnetic flux distribution in the magnetic base body 10 more uniform. Consequently, concentration of the magnetic flux on the first metal magnetic particles 13 can be decreased and therefore the DC bias characteristic of the coil component 1 can be improved.

The operation and effects described about the magnetic base body 10 also applies to other magnetic base bodies (for example, the magnetic base bodies 110 and 210) according to the embodiment of the invention. Further, the operation and effects described about the coil component 1 also applies to other coil components (for example, the coil components 101 and 201) according to the embodiment of the invention.

The dimensions, materials, and arrangements of the constituent elements described herein are not limited to those explicitly described for the embodiments, and these constituent elements can be modified to have any dimensions, materials, and arrangements within the scope of the present invention. Furthermore, constituent elements not explicitly described herein can also be added to the described embodiments, and it is also possible to omit some of the constituent elements described for the embodiments.

What is claimed is:

1. A magnetic base body comprising:
a plurality of first metal magnetic particles made of a first magnetic material and having a first average particle size;
a coating film made of an insulating material that has a magnetic permeability lower than a magnetic permeability of the first magnetic material, the coating film covering each of the plurality of first metal magnetic particles;
a plurality of second metal magnetic particles having a second average particle size smaller than the first average particle size; and
a binder made of a resin material that has a magnetic permeability lower than the magnetic permeability of the first magnetic material, the binder binding the plurality of first metal magnetic particles and the plurality of second metal magnetic particles,
wherein each of the plurality of second metal magnetic particles directly contacts with the binder on its outer surface.

2. The magnetic base body of claim 1, wherein the plurality of second metal magnetic particles are arranged at positions that do not overlap with a virtual center line connecting centers of two adjacent first metal magnetic particles among the plurality of first metal magnetic particles.

3. The magnetic base body of claim 1, wherein at least some of the plurality of second metal magnetic particles are in contact with the coating film.

4. The magnetic base body of claim 1, wherein an aspect ratio of the second metal magnetic particle is in a range of 1.0 to 1.4.

5. The magnetic base body of claim 1, wherein the second average particle size of the plurality of second metal magnetic particles is 10% or less of the first average particle size of the plurality of first metal magnetic particles.

6. The magnetic base body of claim 1, wherein the first average particle size of the plurality of first metal magnetic particles is in a range of 10 to 50 μm.

7. The magnetic base body of claim 1, wherein the second average particle size of the plurality of second metal magnetic particles is in a range of 0.1 to 5 μm.

8. The magnetic base body of claim 1, wherein a distance between two adjacent particles among the plurality of first metal magnetic particles is 10 times or less the second average particle size of the plurality of second metal magnetic particles.

9. The magnetic base body of claim 8, wherein the distance between the two adjacent particles among the plurality of first metal magnetic particles is in a range of 10 nm to 15 μm.

10. The magnetic base body of claim 1, wherein a filling factor of the plurality of first metal magnetic particles and the plurality of second metal magnetic particles together in the magnetic base body is 85% or more.

11. A coil component comprising:
the magnetic base body of claim 1; and
a coil conductor provided in the magnetic base body.
